(19) United States
(12) Patent Application Publication
(10) Pub. No.: US 2026/0212501 A1
(43) Pub. Date: Jul. 23, 2026

(54) METHOD AND SYSTEM FOR EVALUATING BLASTOCYST QUALITY

(71) Applicant: SUZHOU BOUNDLESS MEDICAL TECHNOLOGY CO., LTD., Suzhou (CN)

(72) Inventors: Chunfeng YUE, Suzhou (CN); Hang LIU, Suzhou (CN); Zongjie HUANG, Suzhou (CN)

(21) Appl. No.: 19/457,996

(22) Filed: Jan. 23, 2026

Related U.S. Application Data
(63) Continuation of application No. PCT/CN2024/099124, filed on Jun. 14, 2024.

(30) Foreign Application Priority Data
Jul. 31, 2023 (CN) 202310945870.5

(51) Int. Cl. G06T 7/00; G06N 20/00; G06T 3/40; G06V 10/82; G06V 20/69

(52) U.S. Cl. CPC G06T 7/0012; G06N 20/00; G06T 3/40; G06V 10/82; G06V 20/693; G06V 20/695; G06T 2207/20081; G06T 2207/20084; G06T 2207/30044

(57) ABSTRACT

The present invention relates to a method and system for evaluating blastocyst quality. The method includes: inputting a multi-focus image of a blastocyst into a pre-trained deep learning model, acquiring a development stage of the blastocyst, and acquiring quantitative scores of inner cell mass (ICM) and trophectoderm (TE); acquiring a quantitative score of blastocyst quality from the quantitative scores of ICM and TE; and selecting an optimum blastocyst according to the development stage of the blastocyst and the quantitative score of blastocyst quality. According to the present invention, the quality of blastocysts of the same grade is discriminated, and the overall quality of an embryo is further quantified.

### FIELD OF THE INVENTION

The present invention relates to the field of medical technologies and specifically to a method and system for evaluating blastocyst quality.

### DESCRIPTION OF THE RELATED ART

With the changes of environment, society, economy, and lifestyle, the delay of childbearing age, and other factors, about 8-12% couples of childbearing age in the world are afflicted by infertility. In-vitro fertilization (IVF), as an effective treatment to infertility, helps many infertile couples to successfully obtain offspring. Now, more than 8 million IVF babies are born in the world. IVF involves a process of removing multiple eggs out of a woman's ovary and then fertilizing them with sperm in the laboratory. Then, an embryo with better quality is selected from the embryos formed in this process and put into the uterus for potential transfer. To avoid the health risks and complications caused by multiple pregnancy and multiple births, only a few embryos are generally transferred, and desirably only one embryo is transferred. Therefore, the selection of embryos suitable for transfer has become a key step in IVF treatment.

At present, the criteria for embryo evaluation and selection mainly come from the Gardner grading system of human embryos, which specifies the evaluation of the quality of a blastocyst from three aspects including the development stage of the blastocyst, inner cell mass (ICM) and trophectoderm (TE). The development stage of the blastocyst is divided into phases 1-6 according to the volume of the blastocoel and the thickness of the zona pellucida. ICM is divided into grades A-C according to the number and compactness of cells, and TE is also divided into grades A-C according to the number, compactness, and size of cells. Because this standard is subjective and the embryologists who evaluate the embryos in clinic are subjective, the evaluation varies greatly among different embryologists. Now it is generally recognized in the industry that the quality evaluation of embryos needs objective and quantitative improvement.

One approach is to automatically obtain the development stage of the blastocyst and the ICM and TE grades by analyzing embryo images by the deep learning technology. Because the embryo occupies a three-dimensional space and a single image cannot reflect the whole condition of the embryo, the researchers begin to evaluate the embryo quality by processing a multi-focus image of an embryo by the deep learning technology. The photos in the multi-focus image are respectively focused on different Z-axial planes of the embryo, so the whole condition of the embryo can be more fully reflected.

However, similar to the results of embryo evaluation by the embryologists, the results of embryo evaluation in the above work are to give the development stage of the embryo and the ICM and TE grades such as 4AA and 4BB. However, how to discriminate the quality of blastocysts of the same grade and further quantify the overall quality of the embryos are not solved.

### SUMMARY OF THE INVENTION

To this end, the technical problem to be solved by the present invention is to overcome in the prior art.

To solve the above technical problems, the present invention provides a method for evaluating blastocyst quality, which includes:
inputting a multi-focus image of a blastocyst into a pre-trained deep learning model, acquiring a development stage of the blastocyst, and acquiring quantitative scores of ICM and TE;
acquiring a quantitative score of blastocyst quality from the quantitative scores of ICM and TE; and
selecting an optimum blastocyst according to the development stage of the blastocyst and the quantitative score of blastocyst quality.

In an embodiment of the present invention, the pre-trained deep learning model includes:
training a deep learning model with a pre-processed multi-focus image of the blastocyst, and acquiring the probabilities of ICM and TE grades.

In an embodiment of the present invention, for the ICM and TE grades,
the ICM grades include: grade A, grade B, and grade C; and
the TE grades include: grade A, grade B, and grade C.

In an embodiment of the present invention, the pre-processed multi-focus image of the blastocyst is obtained by a process including:
acquiring multiple photos at different focal planes that are set to have the same resolution; and
segmenting an embryo in each of the photos at different focal planes, filling the embryo to a resolution of a first set size and then scaling to a resolution of a second set size, where
the multiple photos at different focal planes at least include one photo of ICM and one photo of TE.

In an embodiment of the present invention, the acquiring the probabilities of ICM and TE grades includes:
extracting, by a backbone network in the deep learning model, a feature vector from each of the blastocyst images at different focal planes;
acquiring, by imputing the feature vector into a fully connected network in the deep learning model, the development stage of the blastocyst and the ICM and TE grades; and
acquiring, by imputing the development stage of the blastocyst and the ICM and TE grades into the Softmax layer and normalizing, the probabilities of the ICM and TE grades.

In an embodiment of the present invention, the acquiring quantitative scores of ICM and TE includes
acquiring, by weighted summation of the the grade A, grade B, and grade C of ICM and the grade A, grade B, and grade C of TE respectively according to set weights, the quantitative scores of ICM and TE.

In an embodiment of the present invention, the acquiring a quantitative score of blastocyst quality includes
acquiring weights of the quantitative scores of ICM and TE by a pre-trained logistic regression model; and
acquiring, by weighted summation of the quantitative scores of ICM and TE, the quantitative score of blastocyst quality.

In an embodiment of the present invention, the pre-trained logistic regression model includes:
acquiring, according to the quantitative scores of ICM and TE and an embryo clinical outcome, the weights of the quantitative scores of ICM and TE.

In an embodiment of the present invention, the selecting an optimum blastocyst according to the development stage of the blastocyst and the quantitative score of blastocyst quality includes:
selecting a blastocyst with a development stage of the blastocyst that is greater than or equal to phase III; and
based on the selected blastocyst with a development stage of the blastocyst that is greater than or equal to phase III, selecting a blastocyst with the highest quantitative score of blastocyst quality.

The present invention further provides a system for evaluating blastocyst quality includes:
an imaging device: configured to take a multi-focus image of a blastocyst;
a scoring device: configured to determine a development stage of the blastocyst and scores of ICM and TE; and
a selecting device: configured to select a blastocyst with the highest blastocyst quality score.

Compared with the prior art, the technical solution of the present invention has the following advantages:
The present invention provides a method and system for evaluating blastocyst quality. The method includes: inputting a multi-focus image of a blastocyst into a pre-trained deep learning model, acquiring a development stage of the blastocyst, and acquiring quantitative scores of ICM and trophectoderm TE; acquiring a quantitative score of blastocyst quality from the quantitative scores of ICM and TE; and selecting an optimum blastocyst according to the development stage of the blastocyst and the quantitative score of blastocyst quality. According to the present invention, the quality of blastocysts of the same grade is discriminated, and the overall quality of an embryo is further quantified.

### BRIEF DESCRIPTION OF THE DRAWINGS

To make the disclosure of the present invention more comprehensible, the present invention will be further described in detail by way of specific embodiments of the present invention with reference the accompanying drawings, in which:

FIG. 1 is a flowchart of a method for evaluating blastocyst quality according to the present invention;

FIG. 2 is a schematic diagram of a multi-focus image of a blastocyst in the present invention;

FIG. 3 is a schematic diagram of ICM and TE in a blastocyst photo at a focal plane in the present invention;

FIG. 4 is a structural diagram of a deep learning model in the present invention; and

FIG. 5 is a schematic diagram for discriminating the quality of two blastocysts by the blastocyst scores in the present invention.

### DETAILED DESCRIPTION OF THE PREFERRED EMBODIMENTS

The present invention will be further described below with reference to the accompanying drawings and specific examples, so that those skilled in the art can better understand and implement the present invention; however, the present invention is not limited thereto.

### Embodiment 1

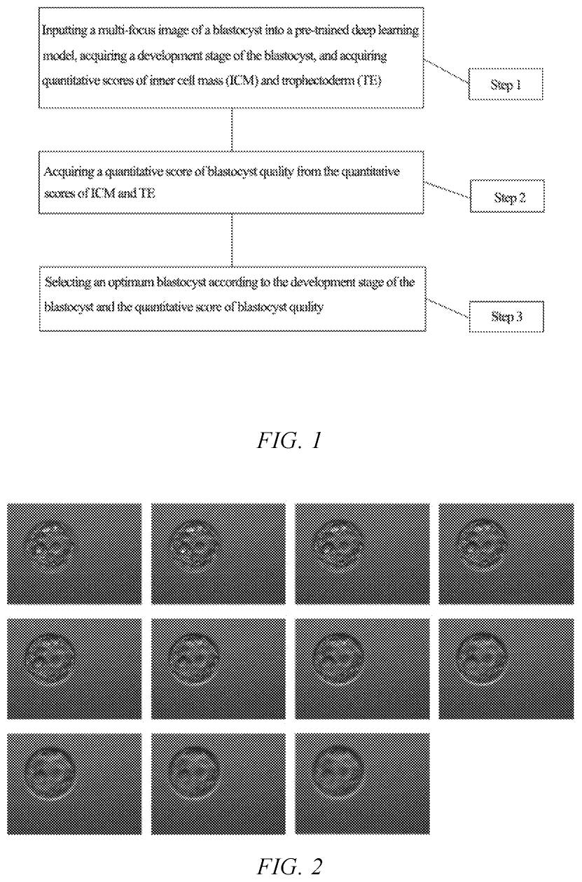

As shown in FIG. 1, a method for evaluating blastocyst quality according to the present invention includes:
inputting a multi-focus image of a blastocyst into a pre-trained deep learning model, acquiring a development stage of the blastocyst, and acquiring quantitative scores of ICM and TE;
acquiring a quantitative score of blastocyst quality from the quantitative scores of ICM and TE; and
selecting an optimum blastocyst according to the development stage of the blastocyst and the quantitative score of blastocyst quality.

The pre-trained deep learning model includes:
training a deep learning model with a pre-processed multi-focus image of the blastocyst, and acquiring the probabilities of ICM and TE grades.

For the ICM and TE grades,
the ICM grades include: grade A, grade B, and grade C; and
the TE grades include: grade A, grade B, and grade C.

The pre-processed multi-focus image of the blastocyst is obtained by a process including:
acquiring multiple photos at different focal planes that are set to have the same resolution; and
segmenting the embryo in each of the photos at different focal planes, filling the embryo to a resolution of a first set size and then scaling to a resolution of a second set size, where
the multiple photos at different focal planes at least include one photo of ICM and one photo of TE.

The acquiring the probabilities of ICM and TE grades includes:
extracting, by a backbone network in the deep learning model, a feature vector from each of the blastocyst photos at different focal planes;
acquiring, by imputing the feature vector into a fully connected network in the deep learning model, the development stage of the blastocyst and the ICM and TE grades; and
acquiring, by imputing the development stage of the blastocyst and the ICM and TE grades into the Softmax layer and normalizing, the probabilities of the ICM and TE grades.

The acquiring quantitative scores of ICM and TE includes:
acquiring, by weighted summation of the grade A, grade B, and grade C of the ICM and the grade A, grade B, and grade C of TE respectively according to set weights, the quantitative scores of ICM and TE.

The acquiring a quantitative score of blastocyst quality includes:
acquiring weights of the quantitative scores of ICM and TE by a pre-trained logistic regression model; and
acquiring, by weighted summation of the quantitative scores of ICM and TE, the quantitative score of blastocyst quality.

The pre-trained logistic regression model includes:
acquiring, according to the quantitative scores of ICM and TE and an embryo clinical outcome, the weights of the quantitative scores of ICM and TE.

The selecting an optimum blastocyst according to the development stage of the blastocyst and the quantitative score of blastocyst quality including:
selecting a blastocyst with a development stage of the blastocyst that is greater than or equal to phase III; and
based on the selected blastocyst with a development stage of the blastocyst that is greater than or equal to phase III, selecting a blastocyst with the highest quantitative score of blastocyst quality.

### Embodiment 2

A method includes acquiring a multi-focus image of a blastocyst, scoring, by a deep learning model, a development stage of the blastocyst, ICM, and TE, and determining the blastocyst quality based on the scores. The multi-focus image at least includes at least two photos, one photo is focused on ICM, and the other photo is focused on TE. ICM and TE scores are obtained by weighted summation of the probabilities of ICM and TE grades A, B, and C predicted by a deep learning model respectively according to weights 3, 2, and 1.

A system includes a device configured to take a multi-focus image of a blastocyst, a device configured to score, by a deep learning model, a development stage of the blastocyst, ICM and TE, and a device configured to determine the blastocyst quality based on the scores. The multi-focus image at least includes at least two photos, one photo is focused on ICM, and the other photo is focused on TE. The ICM and TE scores are obtained by weighted summation of the probabilities of ICM and TE grades A, B, and C determined by a deep learning model respectively according to weights 3, 2, and 1. The development stage of the blastocyst and the ICM and TE grades A, B, and C are determined based on the Gardner grading system of human blastocysts.

A method for determining blastocyst quality includes determining whether the blastocyst is a fully expanded blastocyst by predicting whether the developmental stage of the blastocyst is >phase 3. A method for quantifying the quality of a fully expanded blastocyst includes weighted summation of ICM and TE scores, where the weights are obtained by establishing a logistic regression model of the ICM and TE scores vs a clinical blastocyst outcome.

The probabilities of ICM and TE grades A, B, and C are obtained by normalizing the output of the fully connected layer in the last layer of the deep learning model by the Softmax function.

In the system, the input of the fully connected layer in the last layer of the deep learning model is obtained by connecting the features extracted from the multi-focus image by a backbone network in a convolutional neural network, and the output is the development stage of the blastocyst, and the ICM and TE grades.

The device configured to take a multi-focus image of a blastocyst is an inverted microscope or an embryo time-lapse imaging system.

The system includes:
a device configured to take a multi-focus image of a blastocyst;
a device configured to score, by a deep learning model, a development stage of the blastocyst, ICM and TE;
a device configured to determine, based on the development stage of the blastocyst and ICM and TE scores, the blastocyst quality, where whether the blastocyst is a fully expanded blastocyst is determined according to whether the developmental stage of the blastocyst is >phase 3, and a method for quantifying the quality of a fully expanded blastocyst includes weighted summation of the ICM and TE scores; and
a device configured to select a human blastocyst with the highest human blastocyst quality score.

### Embodiment 3

The quantitative score helps to select a blastocyst of high quality for transfer, so as to improve the success rate of IVF treatment.

In a first aspect, the present invention relates to a method including acquiring a multi-focus image of a blastocyst, scoring a development stage of the blastocyst and ICM and TE grades, and determining the blastocyst quality based on the scores. Particularly, the present invention is applicable to human blastocysts, and the acquired quantitative score of blastocyst quality can be used to identify and select a blastocyst that is most suitable for transfer into the uterus of a woman. The selected blastocyst has a higher probability of providing pregnancy or even giving birth to a live baby, thereby improving the success rate of IVF treatment.

Therefore, in another aspect, the method includes acquiring a multi-focus image of a blastocyst, scoring, by a deep learning model, a development stage of the blastocyst, ICM, and TE, and determining a quantitative score of blastocyst quality based on the scores. The multi-focus image at least includes at least two photos, where one photo is focused on ICM, and the other photo is focused on TE. The ICM and TE scores are obtained by weighted summation of the probabilities of ICM and TE grades A, B, and C determined by a deep learning model respectively according to weights 3, 2, and 1.The development stage of the blastocyst and the ICM and TE grades A, B, and C are determined based on the Gardner grading system of human blastocysts. The quantitative score of blastocyst quality is obtained by weighted summation of the ICM score and TE score according to the weights of 1:1.5.

Therefore, in another aspect, the method includes acquiring a multi-focus image of a blastocyst as defined above, acquiring a quantitative score of blastocyst quality, and selecting a blastocyst with the highest quantitative score of blastocyst quality.

In another aspect, the present invention relates to a system. The system has a device for implementing the above method. The system can be any suitable system, such as a computer including a computer code portion forming a tool for implementing the method as described above. The system may further include a device for obtaining a multi-focus image of an embryo at different focal planes, such as an inverted microscope and an embryo time-lapse imaging system.

In another aspect, the present invention relates to a data carrier, which includes a computer code portion forming a tool for implementing the method as described above.

An embodiment of the present invention provides a method for quantitatively evaluating blastocyst quality and selecting a blastocyst based on a multi-focus image of the blastocyst. The method specifically includes the following steps.

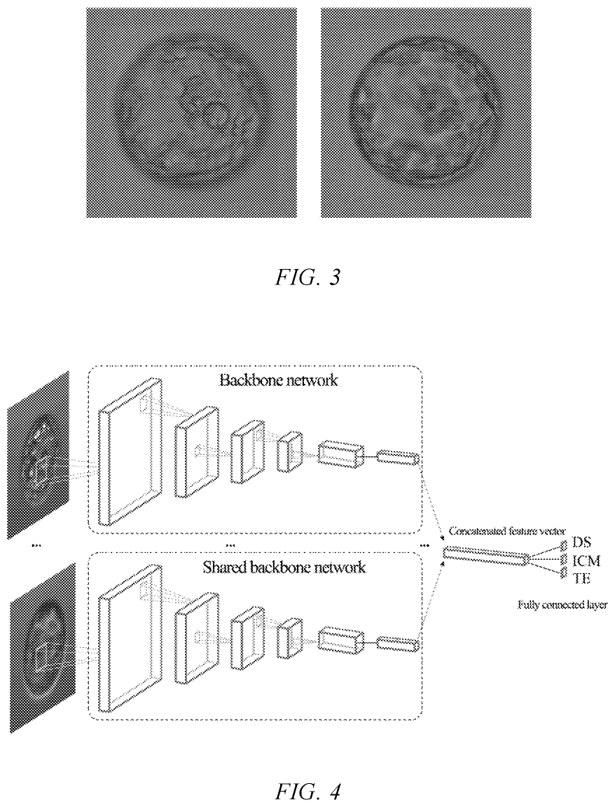

As shown in FIGS. 2 and 3, S1: Acquire a multi-focus image of a blastocyst and pre-process the image. In this embodiment, the multi-focus image of the blastocyst is composed of 11 photos at different focal planes, and has a resolution of 1280×960.

The pre-processing of the image includes segmenting the embryo in each of the photos at different focal planes, filling the embryo to a same size such as 500×500, and then scaling to a size of 300×300. The multi-focus image of the blastocyst at least includes two photos, which are respectively focused on ICM and TE respectively.

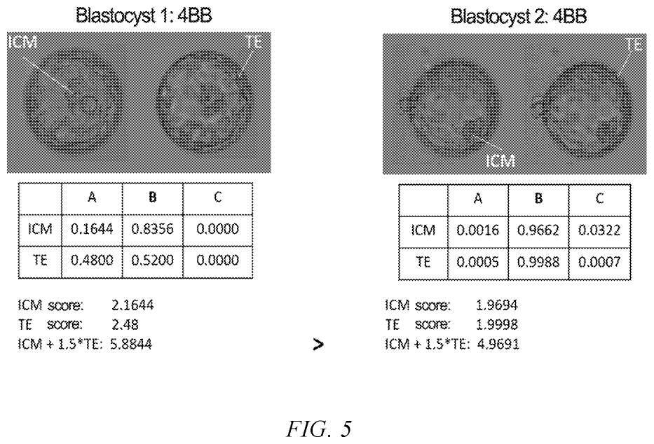

As shown in FIG. 4, S2: Process the multi-focus image of the blastocyst by a deep learning model to obtain a development stage (DS) of the blastocyst, and probabilities of ICM and TE grades. A backbone network in the deep learning model processes each multi-focus image and extracts a feature vector. Densenet121 is used as the backbone network in this embodiment. These feature vectors are connected and used as the input of the fully connected network in the last layer. There are three fully connected networks in the last layer that are used to predict the development stage of the blastocyst, and ICM and TE grades respectively. Their outputs are normalized by the Softmax layer to obtain the probabilities of various grades.

S3: Acquire quantitative scores of ICM and TE according to the probabilities of the ICM and TE grades, and acquire a quantitative score of blastocyst quality. The quantitative scores of ICM and TE are obtained by weighted summation of the probabilities of the ICM and TE grades that are calculated by the deep learning model to belong to grades A, B and C according to the weights of 3:2:1. 3:2:1 correspond to the base scores of grades A, B, and C, and are preset manually. After the quantitative scores of ICM and TE are acquired, the quantitative score of blastocyst quality is obtained by weighted summation of the quantitative scores of ICM and TE according to the weights of 1:1.5. In the embodiment, the weights of 1:1.5 are obtained by establishing a logistic regression model of the quantitative scores of ICM and TE vs a live birth outcome of the blastocyst. After the quantitative scores of ICM and TE are fitted to the clinical embryo outcome (expressed by 0 or 1) by the trained logistic regression model, the weights are obtained from the weight coefficients corresponding to the quantitative scores of ICM and TE in the logistic regression model. The weights can be adjusted by a technician by establishing a logistic regression model of the quantitative scores of ICM and TE vs other clinical outcomes such as euploidy, transfer, and pregnancy.

As shown in FIG. 5, the quality of two blastocysts of the same grade 4BB are discriminated by the quantitative scores of blastocyst quality. The scoring results show that blastocyst 1 is superior to blastocyst 2. Although both blastocysts 1 and 2 are graded as 4BB, ICM and TE of blastocyst 1 are better than those of blastocyst 2. As can be seen, the area of ICM of blastocyst 1 is larger than that of blastocyst 2; and the number and continuity of TE are also better than those of blastocyst 2.

S4: Select an optimum blastocyst according to the development stage of the blastocyst and the quantitative score of blastocyst quality. The optimum blastocyst needs to have a development stage of the blastocyst that is ≥phase 3.

On this basis, the blastocyst with the highest quantitative score of blastocyst quality is the optimum blastocyst.

There are 6 phases of development stages in total. A transferable blastocyst generally reaches phase 4, In some cases, a blastocyst of phase 3 can be transferred to the patient if no blastocyst of phase 4 is available.

### Embodiment 4

The present invention further provides a system for evaluating blastocyst quality. The system includes:
an imaging device: configured to take a multi-focus image of a blastocyst;
a scoring device: configured to determine a development stage of the blastocyst and scores of ICM and TE; and
a selecting device: configured to select a blastocyst with the highest blastocyst quality score.

A person skilled in the art should appreciate that embodiments of the present application provides a method, a system, or a computer program product. Therefore, the present application can be embodied the form of complete hardware, complete software, or software combined with hardware. In addition, the present application can be embodied in the form of a computer program product implemented on one or more computer-usable storage media (including but not limited to a disk storage, CD-ROM, and an optical storage, etc.) containing computer-usable program codes.

The present application is described with reference to the flowchart and/or block diagram of the method, device (system), and computer program product. It should be understood that each flow and/or block in the flowchart and/or block diagram, and combinations of the flow and/or block in the flowchart and/or block diagram can be implemented by the computer program instructions. These computer program instructions may be provided to a processor of a general-purpose computer, a special-purpose computer, an embedded processor or other programmable data processing devices to produce a machine. The instructions executed by the processor of the computer or other programmable data processing devices produce means for implementing the functions specified in one or more flows in the flowchart and/or one or more blocks in the block diagram.

These computer program instructions may also be stored in a computer-readable memory that can direct a computer or other programmable data processing devices to operate in a particular manner, such that the instructions stored in the computer-readable memory produce an article of manufacture including instruction means that implement the functions specified in one or more flows in the flowchart and/or one or more blocks in the block diagram.

These computer program instructions may also be loaded on a computer or other programmable data processing devices, such that a series of operational steps are performed on the computer or other programmable devices to produce computer-implemented processing. In this way, the instructions executed on the computer or other programmable devices provide steps for implementing the functions specified in one or more flows in the flowchart and/or one or more blocks in the block diagram.

Apparently, the above-described embodiments are merely examples provided for clarity of description, and are not intended to limit the implementations of the present invention. Other variations or changes can be made by those skilled in the art based on the above description. The embodiments are not exhaustive herein. Obvious variations or changes derived therefrom also fall within the protection scope of the present invention.

1. A method for evaluating blastocyst quality, comprising:
inputting a multi-focus image of a blastocyst into a pre-trained deep learning model, acquiring a development stage of the blastocyst, and acquiring quantitative scores of inner cell mass (ICM) and trophectoderm (TE);
acquiring a quantitative score of blastocyst quality from the quantitative scores of ICM and TE; and
selecting an optimum blastocyst according to the development stage of the blastocyst and the quantitative score of blastocyst quality.

2. The method according to claim 1, wherein the pre-trained deep learning model comprises:
training a deep learning model with a pre-processed multi-focus image of the blastocyst, and acquiring the probabilities of ICM and TE grades.

3. The method according to claim 2, wherein for the ICM and TE grades,
the ICM grades comprise: grade A, grade B, and grade C; and
the TE grades comprise: grade A, grade B, and grade C.

4. The method according to claim 2, wherein the pre-processed multi-focus image of the blastocyst is obtained by a process comprising:
acquiring multiple photos at different focal planes that are set to have the same resolution; and
segmenting an embryo in each of the photos at different focal planes, filling the embryo to a resolution of a first set size and then scaling to a resolution of a second set size, wherein
the multiple photos at different focal planes at least comprise one photo of ICM and one photo of TE.

5. The method according to claim 2, wherein the acquiring the probabilities of ICM and TE grades comprises:
extracting, by a backbone network in the deep learning model, a feature vector from each of blastocyst images at different focal planes;
acquiring, by inputting the feature vector into a fully connected network in the deep learning model, the development stage of the blastocyst and the ICM and TE grades; and
acquiring, by inputting the development stage of the blastocyst and the ICM and TE grades into the Softmax layer and normalizing, the probabilities of the ICM and TE grades.

6. The method according to claim 3, wherein the acquiring quantitative scores of ICM and TE comprises:
acquiring, by weighted summation of the grade A, grade B, and grade C of ICM and the grade A, grade B, and grade C of TE respectively according to set weights, the quantitative scores of ICM and TE.

7. The method according to claim 1, wherein the acquiring a quantitative score of blastocyst quality comprises:
acquiring weights of the quantitative scores of ICM and TE by a pre-trained logistic regression model; and
acquiring, by weighted summation of the quantitative scores of ICM and TE, the quantitative score of blastocyst quality.

8. The method according to claim 1, wherein the pre-trained logistic regression model comprises:
acquiring, according to the quantitative scores of ICM and TE and an embryo clinical outcome, the weights of the quantitative scores of ICM and TE.

9. The method according to claim 1, wherein the selecting an optimum blastocyst according to the development stage of the blastocyst and the quantitative score of blastocyst quality comprises:
selecting a blastocyst with a development stage of the blastocyst that is greater than or equal to phase III; and
based on the selected blastocyst with a development stage of the blastocyst that is greater than or equal to phase III, selecting a blastocyst with the highest quantitative score of blastocyst quality.

10. A system for evaluating blastocyst quality, for implementing the method for evaluating blastocyst quality according to claim 1, comprising:
an imaging device: configured to take a multi-focus image of a blastocyst;
a scoring device: configured to determine a development stage of the blastocyst and scores of ICM and TE; and
a selecting device: configured to select a blastocyst with the highest blastocyst quality score.
